(19) United States
(12) Patent Application Publication
(10) Pub. No.: US 2016/0063540 A1
(43) Pub. Date: Mar. 3, 2016

(54) METHOD FOR REVENUE GENERATION AND REVENUE SHARING FROM A MOBILE APPLICATION

(71) Applicant: Beijing Jinher Software Co., Lid., Beijing (CN)

(72) Inventor: Runfeng Luan, Beijing (CN)

(21) Appl. No.: 14/645,271

(22) Filed: Mar. 11, 2015

Related U.S. Application Data
(63) Continuation of application No. 14/503,025, filed on Sep. 30, 2014, now abandoned.

(30) Foreign Application Priority Data
Aug. 28, 2014 (CN) 201410432863.6

(51) Int. Cl. G06Q 30/02

(52) U.S. Cl. CPC G06Q 30/0247; G06Q 30/0273; G06Q 30/0267

(57) ABSTRACT

A method to share revenue from advertisements in a mobile application comprises receiving a first indication wirelessly over the Internet from the mobile application of a user denoting a viewing of an advertisement, attributing the viewing to the user of the mobile application, tracking a first revenue generated based on the viewing of the advertisement, identifying an advertiser whose advertisement has been viewed by the user, associating a payment obligation to the advertiser with the first revenue, and determining the first revenue to be shared with the user at a first predetermined rate.

### CROSS-REFERENCE TO RELATED APPLICATIONS

The present application is a continuation application of U.S. patent application Ser. No. 14/503,025, filed Sep. 30, 2014, which claims the benefit of priority to Chinese Patent Application No. 201410432863.6, filed on Aug. 28, 2014, the entire contents of which are expressly incorporated herein by reference.

### TECHNICAL FIELD

The technical field relates to mobile application systems and methods. More particularly, the technical field relates to systems and methods to generate and share revenue from mobile applications.

### BACKGROUND

Due to the overwhelming popularity of mobile communications devices, such as smart phones, tablets and other mobile computing devices, mobile application usage has become an integral part of many users' daily activities. Users, through various mobile applications (or “apps”), share their daily activities, photos, videos and thoughts with others who are using the same mobile application platforms. Such information sharing has evolved from sharing with families and friends to sharing with business relations and even complete strangers.

Although a user may create a customized space on a mobile application, the space exists as part of the larger mobile application platform, the usage of which is limited by the rules and regulations imposed by the platform. As a result, individualized or dedicated mobile applications are becoming increasingly popular because they provide a more personalized way to communicate. An individualized mobile application allows its owner to more directly and efficiently communicate with the owner's intended audience, or users of the individualized mobile application. Such an application gives its owner the flexibility to create a more tailored user experience. For example, the owner may wish to share diaries, blogs, photographs and videos with those who have downloaded and installed the owner's custom application. The owner may similarly tailor the application as a tool to communicate with the owner's colleagues, customers, clients and business contacts in general to provide the latest updates on the owner and/or the owner's company such as product launch, product promotion, sales and other activities directly to the users of the application, bypassing emails and text messaging.

One gating issue for owning an individualized mobile app is cost. The overwhelming majority of available mobile application platforms are created and maintained by large corporations because the cost associated with the creation and maintenance of a mobile application is prohibitive for most companies and individuals. A small number of mobile application developers have offered free or low-cost individualized mobile applications that small companies and individuals may own. These developers conventionally use two monetization models.

One monetization model involves selling mobile applications over a mobile app marketplace. The sale requires a payment of a one-time fee or a subscription. However, this method has not proven to generate enough revenue for the developers to recoup the cost of creating an app. The other model involves selling of advertisements. Under this model, the app developer negotiates advertisements with advertisers and places the advertisements into the mobile application. Under this model, the developer still faces a number of challenges. For one, users of mobile applications have typically found advertisements to be annoying and resisted this model. More importantly, app users have little or no incentive to view advertisements. In addition, advertisers may be reluctant to place advertisements on individualized mobile applications because they often cannot accurately gauge the return on the advertisements. As a result, existing mobile application monetization models do not allow developers to generate sufficient revenue to offer free or low-cost individualized mobile applications.

### SUMMARY

Exemplary embodiments are directed to a computer-executed method and a computer system for generating revenue from mobile applications. The invention also creates an incentive-based system for both owners and users of mobile applications. In addition, the invention provides a method and system that allow advertisers to track the number of instances advertisements are viewed, the number of users who have taken the affirmative step of clicking on advertisements to view additional information about the advertisers and opportunities of direct sales. Accordingly, the present invention is directed to a computer-executed method to share revenue from advertisements in a mobile application that includes receiving a first computer-generated indication, instruction, data or signal wirelessly over the Internet from the mobile application of a user denoting a viewing of an advertisement, attributing the viewing to the user of the mobile application, tracking a first revenue generated based on the viewing of the advertisement, identifying an advertiser whose advertisement has been viewed by the user, associating a payment obligation to the advertiser with the first revenue and determining the first revenue to be shared with the user at a first predetermined rate.

In one non-limiting embodiment, the method further includes determining the first revenue to be shared with an owner of the mobile application at a second predetermined rate.

In another non-limiting embodiment, the method further includes receiving a second computer-generated indication, instruction, data or signal wirelessly over the Internet from the mobile application denoting a click event, wherein the click event represents the user affirmatively clicking on the advertisement and identifying a second revenue generated from the click event.

In yet another non-limiting embodiment, the method further includes providing a communication from the advertiser to the mobile application and identifying a third revenue from providing the communication to the mobile application.

In still another non-limiting embodiment, the method further includes tracking the total number of views of the advertisement and providing the total number of views of the advertisement and user information to the advertiser.

In another non-limiting embodiment, if the user who viewed the advertisement is the owner, the owner is to share the first revenue at a combination of the first and second determined rates.

Also in accordance with one non-limiting embodiment of the prevent invention, there is provided a computer implemented method for generating revenue from a mobile application. The method includes providing an advertisement management platform having at least one processor capable of executing a plurality of computer-executable instructions and at least one memory for storing the instructions, the instructions are capable of, providing an advertisement to the mobile application, receiving a first computer-generated indication, instruction, data or signal from the mobile application attributing a viewing of the advertisement to a user using the mobile application, attributing the viewing to the user, tracking a revenue generated based on the viewing of the advertisement, determining the revenue to be shared with the user at a first predetermined rate and determining the revenue to be shared with an owner of the mobile application at a second predetermined rate.

In one non-limiting embodiment, the method further includes receiving a second computer-generated indication, instruction, data or signal from the mobile application denoting a click event, identifying a second revenue generated from the click event and determining the second revenue to be shared with the user at a third predetermined rate and the owner at a fourth predetermined rate.

In another non-limiting embodiment, the method includes providing a plurality of advertisements to the mobile application, confirming the mobile application is simultaneously displaying the plurality of advertisements, wherein content of an advertisement is reveal only upon the user clicking on the advertisement.

In yet another non-limiting embodiment, the method includes receiving a third computer-generated indication, instruction, data or signal denoting a second click event, wherein the second click event represents the user having clicked on the advertisement, tracking a third revenue generated based on the second click event and determining the third revenue to be shared with the user.

Further in accordance with one non-limiting embodiment of the present invention, there is provided a method to generating revenue from advertisements in a mobile application. The method includes providing information regarding the mobile application to a plurality of advertisers, receiving a first computer-generated indication, instruction, data or signal from the mobile application of a first user denoting a viewing of a first advertisement, associating a first fee to a first advertiser based on the viewing of the first advertisement, receiving a second computer-generated indication, instruction, data or signal from the mobile application of a second user denoting a viewing of a second advertisement, associating a second fee to a second advertiser based on the viewing of the second advertisement, determining a first revenue based on the first fee and determining a second revenue based on the second fee, determining the first revenue to be shared with the first user based at a first predetermined rate and determining the second revenue to be shared with the second user based on the first predetermined rate.

In one non-limiting embodiment, the first revenue is substantially equal to the second revenue. In another embodiment, the first revenue may not be substantially equal to the second revenue.

In another non-limiting embodiment, the first user shares in the second revenue if the second user is referred to the mobile application by the first user.

In yet another non-limiting embodiment of the prevent invention, the method includes providing an advertisement management platform having at least one processor capable of executing a plurality of computer-executable instructions and at least one memory for storing the instructions.

In still another non-limiting embodiment of the present invention, the method further includes receiving by the advertisement management platform a plurality of bids from the advertisers to place an advertisement with the mobile application, and identifying a winning bid based on one or more predetermined factors.

In one non-limiting embodiment, the one or more predetermined factors may include, but are not limited to, price, society values, public interest, and the like.

### BRIEF DESCRIPTION OF THE DRAWINGS

The foregoing and other objects, aspects, features, and advantages of exemplary embodiments will become more apparent and may be better understood by referring to the following description taken in conjunction with the accompanying drawings.

FIG. 1 is a flow chart illustrating an exemplary relationship between and among a developer of an individualized mobile application, the owner of the application and users in accordance with one embodiment of the present invention.

FIG. 2 is an illustration of a revenue sharing method consistent with one embodiment of the present invention.

FIG. 3 is an illustration of a revenue sharing method consistent with another embodiment of the present invention.

FIG. 4 is a block diagram of an exemplary computing device that may be used to implement and execute exemplary computer-executable methods.

The accompanying drawings are not intended to be drawn to scale.

### DETAILED DESCRIPTION OF EMBODIMENTS

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein. Like numbers refer to like elements throughout.

As used herein, the terms “data,” “content” and “information” refer interchangeably to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, hosts, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, hosts, and/or the like.

As used herein, the term “module,” encompasses hardware, software and/or firmware configured or programmed to perform one or more particular functions.

As used herein, the term “computer-readable medium” refers to a non-transitory storage hardware, non-transitory storage device or non-transitory computer system memory that may be accessed by a controller, a microcontroller, a computational system or a module of a computational system to encode thereon computer-executable instructions or software programs. The “computer-readable medium” may be accessed by a computational system or a module of a computational system to retrieve and/or execute the computer-executable instructions or software programs encoded on the medium. The non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM) and the like.

As used herein, the terms “mobile computing device” and “mobile device” refer to any computing or communication device that is portable and is transported in normal usage, and that is capable of communication and that has sufficient processor power and memory capacity to perform the operations described herein. For example, and without limitation, a mobile computing device may include a smartphone, a table computer, a laptop computer, and the like. For example, an app may be provided that executes on mobile device operating systems such as Apple Inc.'s iOS®, Google Inc.'s Android®, or Microsoft Inc.'s Windows 8®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications in a manner that allows for improved interactions between apps while also preserving the privacy and security of consumers. In some embodiments, a mobile operating system may also provide for improved communication interfaces for interacting with external devices (e.g., home automation systems, indoor navigation systems, and the like). Communication with hardware and software modules executing outside of the app is typically provided via application programming interfaces (APIs) provided by the mobile device operating system.

As used herein, the terms “application program,” “mobile application” and “mobile app” refer to computer-executable application software programmed or configured to run on a processing unit of a mobile computing device.

As used herein, the terms “equal” and “substantially equal” refer interchangeably, in a broad lay sense, to exact equality or approximate equality within some tolerance.

Certain embodiments of the present invention are directed to a computer-executed method and computer system for generating revenue from mobile applications. One embodiment also creates an incentive-based system for both owners and users of the mobile applications. In addition, one embodiment provides for a computer-executed method and computer system that allow advertisers to track the number of instances advertisements are viewed, the number of users who have taken the affirmative step of clicking on advertisements to view additional information about the advertisers and opportunities of direct sales.

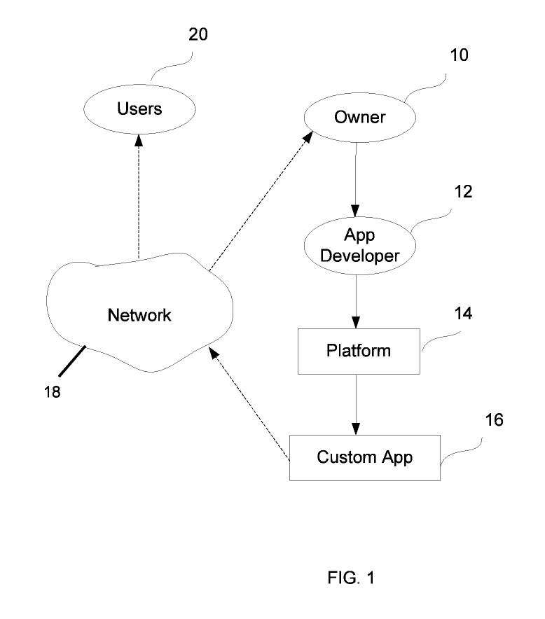

An advertisement-based individualized mobile application is able to generate revenue from targeted advertisements. In developing an individualized mobile application, an owner of the mobile app will be asked to provide certain information that the developer of the mobile app needs to customize the mobile app. FIG. 1 is a flow chart illustrating an exemplary relationship between and among a developer of an individualized mobile application, its owner and users in accordance with one embodiment of the present invention. Referring to FIG. 1, a would-be owner 10 of a custom application contacts a developer 12 of mobile applications. Owner 10 provides information needed to allow app developer 12 to create the custom mobile application. The information may be provided directly to an employee of app developer 12 or through an interactive user interface (not shown) of the website or mobile application (not shown) of the app developer. The information collected by app developer 12 is provided to a mobile application creation platform 14.

The mobile application creation platform 14 is sometimes known as a mobile application software developer's kit. The mobile application creation platform 14 includes templates or libraries that an app developer can use to build a mobile application. The mobile application creation platform 14 creates an individualized or customized mobile application 16 (custom mobile application or custom mobile app) based on the information provided by owner 10. A mobile application includes a set of computer instructions executed on a processor of the mobile device. Custom mobile application 16 is then uploaded to a communications network 18. Owner 10 and any interested persons (users) 20 may download custom mobile application 16 either through a communications network 18. Custom mobile application 16 may be downloaded through the Internet. In one embodiment, communications network 18 is a mobile application marketplace.

The app developer 12 may use the information provided by the owner 10 to identify appropriate advertisements to place. In the event that an owner 10 of a custom app does not agree to allow the developer 12 to use certain information of the owner, or limit the use of personal information, the developer may nevertheless be able to identify appropriate advertisements based on the contents of the app. The present invention allows an app developer to structure a system where advertisers bid to place advertisements with specific mobile apps and allow for the sole advertiser of a specific product or service category based on the information provided by the developer. The bids are sorted, ranked and chosen by an advertisement management platform 28 of the present invention.

In one embodiment of the present invention, selection of a winning bid is not based solely on price. The advertisement management platform 28 may be programmed to take into consideration other factors, such as societal values and public interests, in ranking and choosing a bid. As an example, the advertisement management platform 28 may choose a bid by a nonprofit organization promoting a healthy lifestyle over a higher-priced bid by a company selling candy bars when the mobile application primarily promotes weight loss. The advertisement management platform 28 may also be programmed to bar certain advertisements from appearing in certain categories of mobile apps. In one example, advertisements for alcohol may not be placed in mobile apps intended for minors. The owner of the individualized mobile app may be given limited ability to prevent certain types of ads from being placed onto the app.

The present invention also provides a system and method for more accurately tracking the effectiveness of advertisements. For one, prior to placing an advertisement, information about a particular individualized mobile application is provided to the advertisers to allow an initial assessment. Information provided may include the general nature of the mobile application, the number of users, and the types of advertisements that have already been placed on the app. The information allows for a more educated placement of advertisements. In addition, the advertisers are provided a list of users who have viewed their respective advertisements. A “view event” is generally recognized as when an advertisement appears on the page where a user is currently viewing. A computer-generated indication, instruction, data or signal representing a view event is sent wirelessly over the Internet from the app to the advertisement management platform 28 of the present invention denoting the occurrence of a view event. A view event triggers a payment obligation for the advertiser whose advertisement has just been viewed. The advertisement management platform 28 tracks and records the number of such view events.

The app developer may also determine how much user information to provide or withhold. Generally detailed personal information is not provided, but only sufficient information capable of uniquely identifying users is provided, such as the first name and the first initial of a user's last name. Users' contact information generally is not provided to the advertisers. The ability to uniquely identify the users provides a more accurate means for the advertisers to determine how many times their advertisements have been viewed and how many times a same user viewed a given advertisement. In addition, the advertisement management platform 28 tracks instances when a user takes the affirmative step of clicking on an advertisement. The app sends a computer-generated indication, instruction, data or signal wirelessly over the Internet denoting such a click event to the advertisement management platform 28 to allow the advertisement management platform to track and record the number of such click events. Depending on the requirements of the advertiser, the click event signal may prompt the advertisement management platform 28 to transmit additional information over the Internet from its database for the app to display. Alternatively, the click event signal is directed instead to another server designated by the advertiser for further communication between the advertiser and user, such as providing content from the server for the app to display regarding the advertised product or service. Such an event triggers another fee payment obligation for the advertiser whose advertisement has just been clicked.

In one embodiment, the present invention provides an opportunity for direct sales. The app developer may permit a message to be sent, through the developer's advertisement management platform 28, to a user who appears to have shown an interest in an advertisement by clicking on the advertisement. Such direct access is highly valued and therefore may be permitted for an additional fee to the app developer. When contacted by an advertiser, the user may receive certain benefits as will be discussed later, regardless of whether the user responds to the communication. Such an arrangement is likely to lessen the perceived annoyance or invasion of privacy by the user of having been contacted by an advertiser. If the user responds to the advertiser's communication, such an event may trigger another fee payment obligation on the part of the advertiser. Similarly, the user may receive an additional benefit.

The advertisement management platform 28 is generally a computer with a processor executing a set of computer instructions and at least one memory to store the instructions and other data generated therefrom. The advertisement management platform 28 includes software that stores and tracks information regarding the owner and users and advertisers' contents. The advertisement management platform 28 also interacts wirelessly through the Internet with the apps to monitor usage of a mobile application. The advertisement management platform 28 is configured to receive indications, data, instructions or signals from mobile apps denoting view events or click events from the apps. The advertisement management platform 28 is programmed to keep track of any event triggering a fee payment by an advertiser arising from an action on the part of the owner, users, and/or advertisers. The advertisement management platform 28 is also configured to track revenue generated therefrom and the appropriate revenue sharing allocations, which will be discussed more in detail. In one embodiment, the advertisement management platform 28 is configured to track revenue generated based on mobile application usage, such as view and click events.

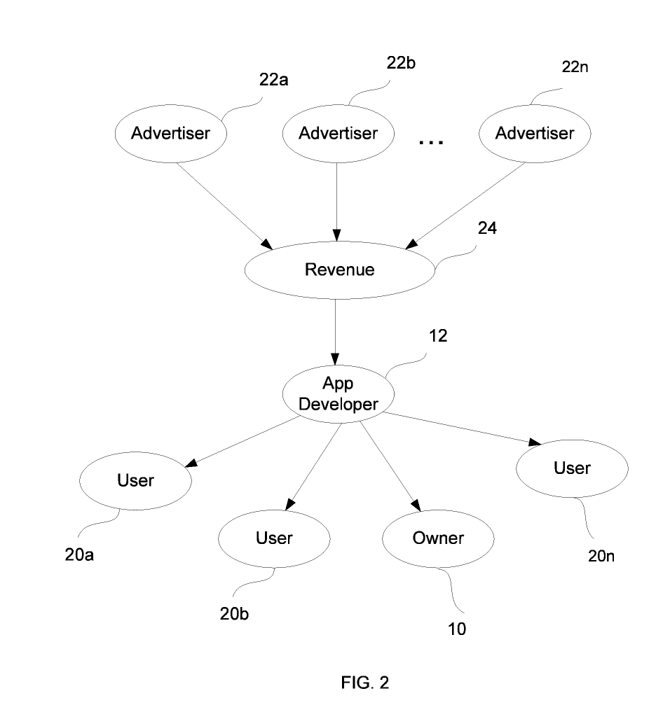

The present invention is also directed to a method and system to incentivize both the owner and users of the custom mobile application in order to maximum revenue from advertisements. FIG. 2 is an illustration of a revenue sharing method consistent with one embodiment of the present invention. Referring to FIG. 2, a plurality of advertisers 22a, 22b . . . 22n, place their advertisements with a custom app, thereby generating a revenue stream 24. Revenue 24 generated from the advertisements is collected by app developer 12. App developer 12 then shares a pre-negotiated amount from revenue 24 with owner 10. App developer may also share revenue 24 with users 20a, 20b . . . and 20n of the custom app.

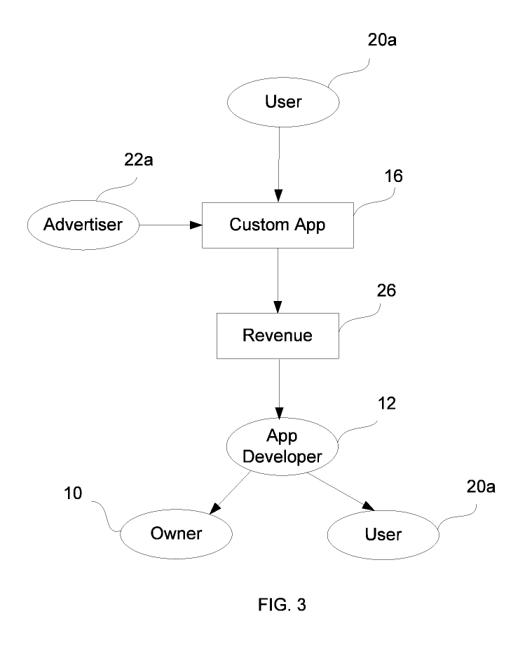

FIG. 3 is an illustration of a revenue sharing method consistent with another embodiment of the present invention. Referring to FIG. 3, user 20a accesses custom mobile application 16 and views an advertisement in custom mobile application 16. Based on an agreement between app developer and advertiser 22, advertiser 22a pays for the user's view of the advertisement, thereby generating revenue 26. Revenue 26, generated from the viewing of one advertisement, is collected by app developer 12. App developer 12 then shares a pre-negotiated amount of revenue 26 with owner 10 and user 20a. In the event that the person who viewed the advertisement is owner 10, owner 10 also receives the amount that otherwise would have gone to user 20a.

The method of the present invention benefits the app developer, owner and users. The benefit allows the app developer to develop apps on a discounted rate or free of charge. The method also incentivizes both the owner of the custom app and its users. For an owner, revenue-sharing provides an incentive to accept advertisements and minimize any limitation the owner may wish to put on the placement of certain types of advertisements. In addition, the owner will be motivated to encourage as many downloads and usage of his/her custom app as possible. With an increased app usage, the app developer will be able to charge advertisers a higher price to place their advertisements with that custom app.

The users of the custom app are likewise benefited from using the custom app. The method and system of the present invention also share the revenue directly with the users. This revenue-sharing method provides an incentive for the users to use the custom app and is likely to render advertisements less objectionable to the users when they appear in the custom app. Therefore, whenever a user views an advertisement on a custom mobile app, the user shares in the revenue generated therefrom. Whenever a user clicks on an advertisement, the user shares in the revenue generated therefore. Whenever a user is contacted by an advertiser, the user shares in the revenue generated therefore. In each instance, the owner of the custom app also shares in the revenue generated by the actions of the app users.

In another embodiment of the present invention, the advertisement management platform 28 may render an advertisement that can only be viewed if a user takes the affirmative step of clicking on it. With this embodiment, the advertiser is not charged a fee, or a fee that is lower than the other advertisements. When a user clicks on the advertisement, the event triggers a fee payment obligation to the advertiser, at a higher rate than the other types of advertisements. Likewise, the user shares in a higher percentage of the revenue generated therefrom. This embodiment additional provides an incentive for users of the custom app to interact with the advertisement.

In another embodiment, this type of advertisements may be placed on an “ad wall” that awaits users to interact with any or all of the advertisements. As already discussed, interactions with any advertisement on the ad wall will trigger a higher fee payment event by the advertisers and also results in higher revenue sharing with the users. Advertisers are generally willing to pay for a higher fee for this type of advertisement because there is the assurance that the users who clicked on the advertisements will have at least actually viewed them.

The present invention discloses an additional embodiment to generate advertisement revenue through referrals. In this embodiment, a user of a customized mobile application may refer the app to another user. When additional individuals download and use the app, the user will be credited with the referrals and benefit financially from the referrals. The developer of the custom app may devise a flat-fee payment method for referrals. Alternatively, the user may share in the additional revenue generated due to the credited referrals. In one embodiment, the additional revenue to be shared with the user because of the referrals will come from additional revenue received by the app developer. A referral may be tracked by the advertisement management platform 28 of the present invention using, for example, metadata or a link embodying a unique identifier identifying the user as the source of the referral when a new user download the app. Alternatively, the user may provide a unique identifier provided or assigned by the app and any additional user can simply input the unique identifier when prompted by the advertisement management platform 28 during the download of the app. The present invention therefore provides an additional incentive for a user of a custom application to encourage as many new users as possible to download and use the custom application.

In one embodiment of the present invention, the sharing of the revenue generated from advertisements is based on digital currency. The digital currency may be an existing Internet currency or one developed by the app developer. Revenue is converted to digital currency for purposes of revenue sharing. Instead of receiving fiat money, the owner and users of the customs apps receive digital currency instead. The digital currency may be accumulated, traded, gifted, or purchased. The digital current may also be exchanged for fiat money. The digital currency may be exchanged for products and merchandize from an Internet marketplace, such as one owned by the app developer.

Systems and methods disclosed herein may include one or more programmable processing units having associated therewith executable instructions held on one or more computer readable media, RAM, ROM, hard drive, and/or hardware. In exemplary embodiments, the hardware, firmware and/or executable code may be provided, for example, as upgrade module(s) for use in conjunction with existing infrastructure (for example, existing devices/processing units). Hardware may, for example, include components and/or logic circuitry for executing the embodiments taught herein as a computing process.

Displays and/or other feedback means may also be included, for example, for rendering a graphical user interface, according to the present disclosure. The display and/or other feedback means may be stand-alone equipment or may be included as one or more components/modules of the processing unit(s).

The actual software code or control hardware which may be used to implement some of the present embodiments is not intended to limit the scope of such embodiments. For example, certain aspects of the embodiments described herein may be implemented in code using any suitable programming language type such as, for example, assembly code, C, C# or C++ using, for example, conventional or object-oriented programming techniques. Such code is stored or held on any type of suitable non-transitory computer-readable medium or media such as, for example, a magnetic or optical storage medium.

As used herein, a “processor,” “processing unit,” “computer” or “computer system” may be, for example, a wireless or wire line variety of a microcomputer, minicomputer, server, mainframe, laptop, personal data assistant (PDA), wireless e-mail device (for example, “BlackBerry,” “Android” or “Apple,” trade-designated devices), cellular phone, pager, processor, fax machine, scanner, or any other programmable device configured to transmit and receive data over a network. Computer systems disclosed herein may include memory for storing certain software applications used in obtaining, processing and communicating data. It can be appreciated that such memory may be internal or external to the disclosed embodiments. The memory may also include non-transitory storage medium for storing software, including a hard disk, an optical disk, floppy disk, ROM (read only memory), RAM (random access memory), PROM (programmable ROM), EEPROM (electrically erasable PROM), flash memory storage devices, or the like.

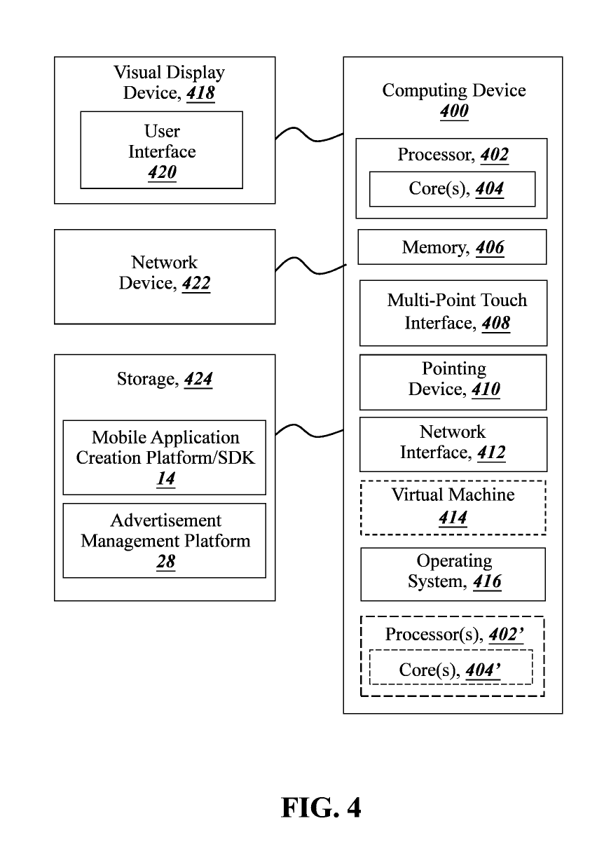

FIG. 4 depicts a block diagram representing an exemplary computing device 400 that may be used to implement the systems and methods disclosed herein. The computing device 400 may be any computer system, such as a workstation, desktop computer, server, laptop, handheld computer, tablet computer (e.g., the iPad™ tablet computer), mobile computing or communication device (e.g., the iPhone™ mobile communication device, the Android™ mobile communication device, and the like), or other form of computing or telecommunications device that is capable of communication and that has sufficient processor power and memory capacity to perform the operations described herein. In exemplary embodiments, a distributed computational system may include a plurality of such computing devices.

The computing device 400 includes one or more non-transitory computer-readable media having encoded thereon one or more computer-executable instructions or software for implementing the exemplary methods described herein. The non-transitory computer-readable media may include, but are not limited to, one or more types of hardware memory and other tangible media (for example, one or more magnetic storage disks, one or more optical disks, one or more USB flash drives), and the like. For example, memory 406 included in the computing device 400 may store computer-readable and computer-executable instructions or software for implementing a graphical user interface as described herein. The computing device 400 also includes processor 402 and associated core 404, and in some embodiments, one or more additional processor(s) 402′ and associated core(s) 404′ (for example, in the case of computer systems having multiple processors/cores), for executing computer-readable and computer-executable instructions or software stored in the memory 402 and other programs for controlling system hardware. Processor 402 and processor(s) 402′ may each be a single core processor or a multiple core (404 and 404′) processor.

Virtualization may be employed in the computing device 400 so that infrastructure and resources in the computing device may be shared dynamically. A virtual machine 414 may be provided to handle a process running on multiple processors so that the process appears to be using only one computing resource rather than multiple computing resources. Multiple virtual machines may also be used with one processor.

Memory 406 may include a computer system memory or random access memory, such as DRAM, SRAM, EDO RAM, and the like. Memory 406 may include other types of memory as well, or combinations thereof.

A user may interact with the computing device 400 through a visual display device 418, such as a screen or monitor, which may display one or more graphical user interfaces 420 provided in accordance with exemplary embodiments described herein. The visual display device 418 may also display other aspects, elements and/or information or data associated with exemplary embodiments.

The computing device 400 may include other I/O devices for receiving input from a user, for example, a keyboard or any suitable multi-point touch interface 408 or pointing device 410 (e.g., a mouse, a user's finger interfacing directly with a display device). As used herein, a “pointing device” is any suitable input interface, specifically, a human interface device, that allows a user to input spatial data to a computing system or device. In an exemplary embodiment, the pointing device may allow a user to provide input to the computer using physical gestures, for example, pointing, clicking, dragging, dropping, and the like. Exemplary pointing devices may include, but are not limited to, a mouse, a touchpad, a finger of the user interfacing directly with a display device, and the like.

The keyboard 408 and the pointing device 410 may be coupled to the visual display device 418. The computing device 400 may include other suitable conventional I/O peripherals. The I/O devices may facilitate implementation of the one or more graphical user interfaces 420, for example, implement one or more of the graphical user interfaces described herein.

The computing device 400 may include one or more storage devices 424, such as a durable disk storage (which may include any suitable optical or magnetic durable storage device, e.g., RAM, ROM, Flash, USB drive, or other semiconductor-based storage medium), a hard-drive, CD-ROM, or other computer readable media, for storing data and computer-readable instructions and/or software that implement exemplary embodiments as taught herein. In exemplary embodiments, the one or more storage devices 424 may provide storage for data that may be generated or received by the systems and methods of the present disclosure, for example, data or information on the owner and/or users of a mobile application. The storage device 424 may provide storage for non-transitory computer-executable instructions that, when executed on a computer processor, perform the operations embodied in a mobile application creation platform 14 and an advertisement management platform 28. The one or more storage devices 424 may be provided on the computing device 400 and/or provided separately or remotely from the computing device 400. The exemplary components depicted as being stored on storage device 424 may be stored on the same or on different storage devices.

The computing device 400 may include a network interface 412 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 412 may include a built-in network adapter, network interface card, PCMCIA network card, card bus network adapter, wireless network adapter, USB network adapter, modem or any other device suitable for interfacing the computing device 400 to any type of network capable of communication and performing the operations described herein. The network device 422 may include one or more suitable devices for receiving and transmitting communications over the network including, but not limited to, one or more receivers, one or more transmitters, one or more transceivers, one or more antennae, and the like.

The computing device 400 may run any operating system 416, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 416 may be run in native mode or emulated mode. In an exemplary embodiment, the operating system 416 may be run on one or more cloud machine instances.

One of ordinary skill in the art will recognize that exemplary computing device 400 may include more or fewer modules than those shown in FIG. 4.

In describing exemplary embodiments, specific terminology is used for the sake of clarity. For purposes of description, each specific term is intended to, at least, include all technical and functional equivalents that operate in a similar manner to accomplish a similar purpose. Additionally, in some instances where a particular exemplary embodiment includes a plurality of system elements or method steps, those elements or steps may be replaced with a single element or step. Likewise, a single element or step may be replaced with a plurality of elements or steps that serve the same purpose. Further, where parameters for various properties are specified herein for exemplary embodiments, those parameters may be adjusted up or down by 1/20th, 1/10th, ⅕th, ⅓rd, ½nd, and the like, or by rounded-off approximations thereof, unless otherwise specified. Moreover, while exemplary embodiments have been shown and described with references to particular embodiments thereof, those of ordinary skill in the art will understand that various substitutions and alterations in form and details may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than shown.

Blocks of the block diagram and the flow chart illustrations support combinations of means for performing the specified functions, combinations of steps for performing the specified functions and program instruction means for performing the specified functions. It will also be understood that some or all of the blocks/steps of the circuit diagram and process flowchart, and combinations of the blocks/steps in the circuit diagram and process flowcharts, can be implemented by special purpose hardware-based computer systems that perform the specified functions or steps, or combinations of special purpose hardware and computer instructions. Exemplary systems may include more or fewer modules than those illustrated in the exemplary block diagrams.

Many modifications, combinations and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications, combinations and other embodiments are intended to be included within the scope of the appended claims. Although specific terms are employed herein, they are used in a generic and descriptive sense only and not for purposes of limitation.

1. A computer-executed method for providing a custom mobile application, comprising:
receiving mobile application specifications from an owner defining content of the custom mobile application;
generating, based on the mobile application specifications and by a mobile application creation platform, the custom mobile application configured to be installed and executed on mobile devices of users, wherein the custom mobile application is further configured to display advertisements when executing on the mobile devices;
providing the custom mobile application to a mobile device of a user over the Internet;
associating an advertisement of an advertiser with the custom mobile application based on a comparison of content of the advertisement with the content of the custom mobile application;
providing the advertisement to the custom mobile application;
receiving a first indication wirelessly over the Internet from the custom mobile application of the mobile device, the first indication denoting a viewing of the advertisement displayed within the mobile application;
attributing the viewing to the user of the custom mobile application;
programmatically tracking a first revenue generated based on the viewing of the advertisement;
programmatically identifying the advertiser of the advertisement that has been viewed by the user;
programmatically associating a payment obligation to the advertiser with the first revenue; and
programmatically determining the first revenue to be shared with the owner at a first predetermined rate.

2. The computer-executed method of claim 1, further comprising determining the first revenue to be shared with the user of the custom mobile application at a second predetermined rate.

3. The computer-executed method of claim 1, further comprising,
receiving a second indication wirelessly over the Internet from the custom mobile application denoting a click event, wherein the click event represents the user affirmatively clicking on the advertisement; and
identifying a second revenue generated from the click event.

4. The computer-executed method of claim 1, further comprising
providing a communication from the advertiser to the custom mobile application; and
identifying a third revenue from providing the communication to the custom mobile application.

5. The computer-executed method of claim 1, further comprising providing information regarding the user to the advertiser upon the viewing of the advertisement.

6. The computer-executed method of claim 1, wherein the sharing of the first revenue is based on a digital currency.

7. The computer-executed method of claim 1, further comprising:
tracking the total number of views of the advertisement; and
providing the total number of views of the advertisement and user information to the advertiser.

8. The computer-executed method of claim 2, further comprising determining the first revenue to be shared with a developer of the custom mobile application at a third predetermined rate.

9. The computer-executed method of claim 2, wherein if the user who viewed the advertisement is the owner, the owner is to share the first revenue at a combined first and second determined rates.

10. The computer-executed method of claim 4, further comprising:
receiving a response to the communication from the custom mobile application; and
identifying a fourth revenue from receiving the response.

11. The computer-executed method of claim 10, further comprising providing the response to the communication to the advertiser.

12. A computer-implemented method for providing a custom mobile application, comprising:
providing a mobile application creation platform having at least one processor capable of executing a plurality of first computer-executable instructions and at least one memory for storing the first instructions, the first instructions being capable of:
receiving mobile application specifications from an owner defining content of the custom mobile application;
generating, based on the mobile application specifications, the custom mobile application configured to be installed and executed on mobile devices of users, wherein the custom mobile application is further configured to display advertisements when executing on the mobile devices;
providing the custom mobile application to a mobile device of a user over the Internet;
providing an advertisement management platform having at least one processor capable of executing a plurality of second computer-executable instructions and at least one memory for storing the second instructions, the second instructions being capable of:
associating an advertisement of an advertiser with the custom mobile application based on a comparison of content of the advertisement with the content of the custom mobile application;
providing the advertisement to the custom mobile application of the mobile device;
receiving a first indication from the custom mobile application attributing a viewing of the advertisement to the user using the custom mobile application;
attributing the viewing to the user;
tracking a revenue generated based on the viewing of the advertisement;
determining the revenue to be shared with the user at a first predetermined rate; and
determining the revenue to be shared with the owner of the custom mobile application at a second predetermined rate.

13. The computer-implemented method of claim 12, further comprising:
identifying the advertiser whose advertisement has been viewed by the user; and
identifying a payment obligation on the advertiser for the revenue.

14. The computer-implemented method of claim 12, further comprising:
receiving a second indication from the custom mobile application denoting a click event;
identifying a second revenue generated from the click event; and
determining the second revenue to be shared with the user at a third predetermined rate and the owner at a fourth predetermined rate.

15. The computer-implemented method of claim 12, further comprising:
providing a plurality of advertisements to the custom mobile application; and
confirming the custom mobile application is simultaneously displaying the plurality of advertisements, wherein content of an advertisement is revealed only upon the user clicking on the advertisement.

16. The computer-implemented method of claim 15, further comprising:
receiving a third indication denoting a second click event, wherein the second click event represents the user having clicked on the advertisement;
tracking a third revenue generated based on the second click event; and
determining the third revenue to be shared with the user.

17. A computer-executed method, comprising:
receiving mobile application specifications from an owner defining content of the custom mobile application;
generating, based on the mobile application specifications and by a mobile application creation platform, a custom mobile application configured to be installed and executed on mobile devices of users, wherein the custom mobile application is further configured to display advertisements when executing on the mobile devices;
providing the custom mobile application to a mobile device of a first user over the Internet;
providing information regarding the custom mobile application to a plurality of advertisers;
associating an advertisement of an advertiser with the custom mobile application based on a comparison of content of the advertisement with the content of the custom mobile application;
receiving a first indication from the custom mobile application of the first user denoting a viewing of a first advertisement;
associating a first fee to a first advertiser based on the viewing of the first advertisement;
receiving a second indication from the custom mobile application of a second user denoting a viewing of a second advertisement;
associating a second fee to a second advertiser based on the viewing of the second advertisement;
determining a first revenue based on the first fee and determining a second revenue based on the second fee;
determining the first revenue to be shared with the first user based at a first predetermined rate;
determining the second revenue to be shared with the second user based on the first predetermined rate; and
determining the first and second revenue to be shared with the owner based on a third predetermined rate.

18. The computer-executed method of claim 17, wherein the first revenue is equal to the second revenue.

19. The computer-executed method of claim 17, where the first user shares in the second revenue if the second user is referred to the mobile application by the first user.

20. The computer-executed method of claim 18, wherein the share in the second revenue by the second user remains unchanged.

21. The computer-executed method of claim 17, further comprising:
providing an advertisement management platform having at least one processor capable of executing a plurality of computer-executable instructions and at least one memory for storing the instructions.

22. The computer-executed method of claim 19, further comprising:
receiving by the advertisement management platform a plurality of bids from the advertisers to place an advertisement with the custom mobile application; and
identifying a winning bid based on one or more predetermined factors.

23. The computer-executed method of claim 22, wherein the one or more predetermined factors include price, society values, or public interest.

24. The computer-executed method of claim 17, further comprising:
forwarding a communication from one of the plurality of advertisers to a third user,
associating a fourth fee to the advertiser whose communication is to be forwarded to the third user, and
determining the fourth fee to be shared with the third user based on a fourth predetermined rate.

25. The computer-executed method of claim 24, further comprising:
forwarding a response from the third user to the communication to the advertiser,
associating a fourth fee to the advertiser whose communication has been responded to by the third user, and
determining the fourth fee to be shared with the third user based on a fourth fifth predetermined rate.
